(19) United States
(12) Patent Application Publication
(10) Pub. No.: US 2009/0037625 A1
(43) Pub. Date: Feb. 5, 2009

(54) Hard disk adaptor

(76) Inventor: Xiang Li, Shanghai (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 11/882,348

(22) Filed: Aug. 1, 2007

(51) Int. Cl. G06F 13/12

(52) U.S. Cl. 710/74

(57) ABSTRACT

A hard disk adaptor includes a substrate and an interface structure. The substrate has a connecting side and a communicating side opposite to the connecting side. The thickness of the substrate corresponds to the Mini-Serial Attached SCSI standard. The interface structure is disposed on the middle of the connecting side, and the interface structure corresponds to the Mini-Serial Attached SCSI standard. The interface structure is a concaving and protruding structure. The interface structure has a protruding portion and two concaving portions formed on the two opposite sides of the protruding portion. The protruding portion has a conductive portion. The hard disks having different interfaces are respectively connected to the unitary standard interfaces of a middle board by the interface structure. Therefore, the cost of the hard disk adaptor is reduced, the structure of the hard disk adaptor and the assembly of the hard disk and the middle board is simpler.

### BACKGROUND OF THE INVENTION

1. Field of the Invention

The present invention relates to a hard disk adaptor and in particular to a hard disk adaptor for a storage system or a server. The hard disk adaptor has different interfaces that are respectively connected to the unitary standard interfaces of a middle board via the interface structure. Therefore, compared to the prior art, the cost of the hard disk adaptor is reduced, the structure of the hard disk adaptor is simpler, and the assembly of the hard disk and middle board is simpler.

2. Description of Related Art

In disk storage systems, disks having different interfaces are connected to a unitary standard interface via a hard disk adaptor so as to connect the disks and a middle board. Therefore, disks having different interfaces can be used in a single disk storage system.

In a common disk storage system that uses 3.5 inch hard disks, a hard disk adaptor connects to a middle board that is an SCAII or an SAS interface standard. The interface of the hard disk adaptor can be an SCAII plug, and the interface of the middle board can be an SCAII socket. Alternatively, the interface of the hard disk adaptor can be an SAS plug, and the interface of the middle board can be an SAS socket. Therefore, the disks can be connected to the middle board via the hard disk adaptor.

However, in a common disk storage system using 2.5 inch hard disks, space for a hard disk adaptor and a middle board is lacking. Therefore, the circuit design of the middle board is difficult when the disks using the SCAII or SAS interface standard connect to the middle board.

### SUMMARY OF THE INVENTION

It is an object of the present invention to provide a hard disk adaptor. The interface structure and the thickness of the substrate correspond to the Mini-Serial Attached SCSI standard. The hard disks have different interfaces that are connected to the unitary standard interfaces of the middle board by the technique of combining the substrate with the interface structure. Moreover, the way of connecting the interface is “plate to board”. Consequently, the complex structure and assembly of the traditional plug and socket is improved via the connection between the different interfaces using the simple design of the substrate and the interface structure. Furthermore, compared to the prior art, the cost of the hard disk adaptor is reduced, the structure of the hard disk adaptor is simpler, and the assembly of the hard disk and middle board is simpler.

To achieve the above object, the present invention provides a hard disk adaptor comprising a substrate and an interface structure. The substrate has a connecting side and a communicating side opposite to the connecting side. The interface structure is formed on the connecting side, and the interface structure corresponds to the Mini-Serial Attached SCSI standard.

Moreover, the thickness of the substrate corresponds to the Mini-Serial Attached SCSI standard. The interface structure has a protruding portion and two concaving portions formed on the two opposite sides of the protruding portion. The protruding portion and the concaving portions correspond to the Mini-Serial Attached SCSI standard. The protruding portion has a conductive portion. The upper surface of the interface structure has a conductive portion. Alternatively, the upper and lower surfaces of the interface structure can have conductive portions. The interface structure is disposed on the middle of the connecting side.

Furthermore, the substrate is connected to a middle board and a hard disk, the interface structure of the connecting side of the substrate is connected to the middle board, and the communicating side is connected to the hard disk.

Therefore, the substrates having the interface structure respectively connect the disks having different interfaces to the unitary standard interfaces of a middle board. The cost of the hard disk adaptor is reduced, and the structure of the hard disk adaptor is simpler.

### BRIEF DESCRIPTION OF THE DRAWINGS

The present invention can be fully understood from the following detailed description and preferred embodiments with reference to the accompanying drawings, in which:

FIG. 1 is a perspective view of the hard disk adaptor according to the present invention;

FIG. 2 is a top view of the hard disk adaptor according to the present invention;

FIG. 3 is a top view of the hard disk adaptor assembled with the disk according to the present invention;

FIG. 4 is a side view of the hard disk adaptor assembled with the disk and the middle board according to the present invention;

FIG. 5 is a top view of the hard disk adaptor assembled with the disk and the middle board according to the present invention;

FIG. 6 is a perspective view of the hard disk adaptor assembled with the disk and the middle board according to the present invention.

### DETAILED DESCRIPTION OF THE PREFERRED EMBODIMENTS

The following detailed description is of the best presently contemplated modes of applying the invention. This description is not intended to be taken in a limiting sense, but is made merely for the purpose of illustrating general principles of embodiments of the invention. The scope of the invention is best defined by the appended claims.

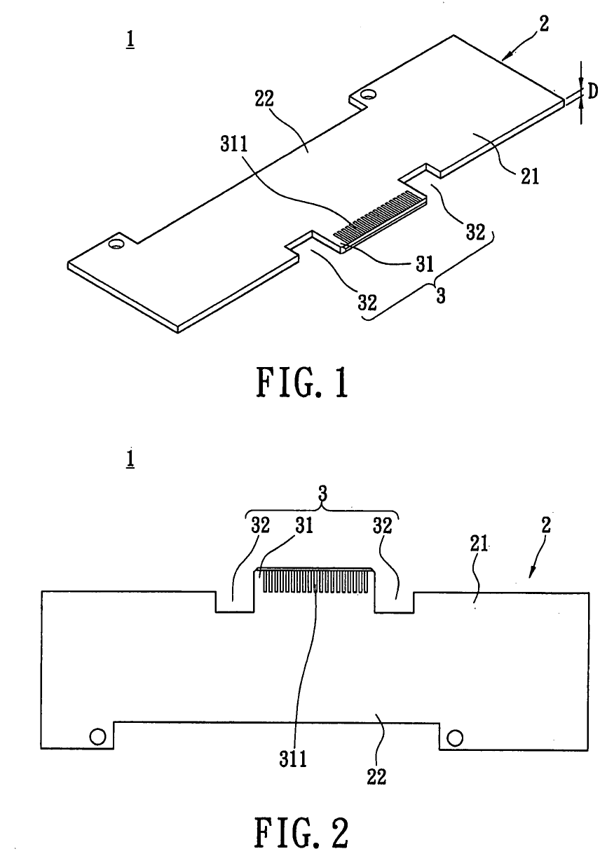

Please refer to FIGS. 1 and 2, which show the perspective view and side view of a hard disk adaptor of the present invention. The hard disk adaptor 1 comprises a substrate 2 and an interface structure 3. The substrate 2 has a connecting side 21 and a communicating side 22. The connecting side 21 is opposite to the communicating side 22. The interface structure 3 is formed on the connecting side 21. The interface structure 3 can be a Mini-Serial Attached SCSI interface standard.

In the embodiment, the interface structure 3 is formed on the middle of the connecting side 21. However, the position of the interface structure 3 in the connecting side 21 is not limited. The interface structure 3 has a protruding portion 31. Two concaving portions 32 are formed on the two opposite sides of the protruding portion 31, respectively. The upper surface of the protruding portion 31 has a conductive portion 311 that acts as a transferring interface. In the other embodiment, both the upper and lower surfaces of the protruding portion 31 have the conductive portion 311. Moreover, the thickness D of the substrate 2, the protruding portion 31, and the concaving portions 32 correspond to the Mini-Serial Attached SCSI standard for a high transferring speed.

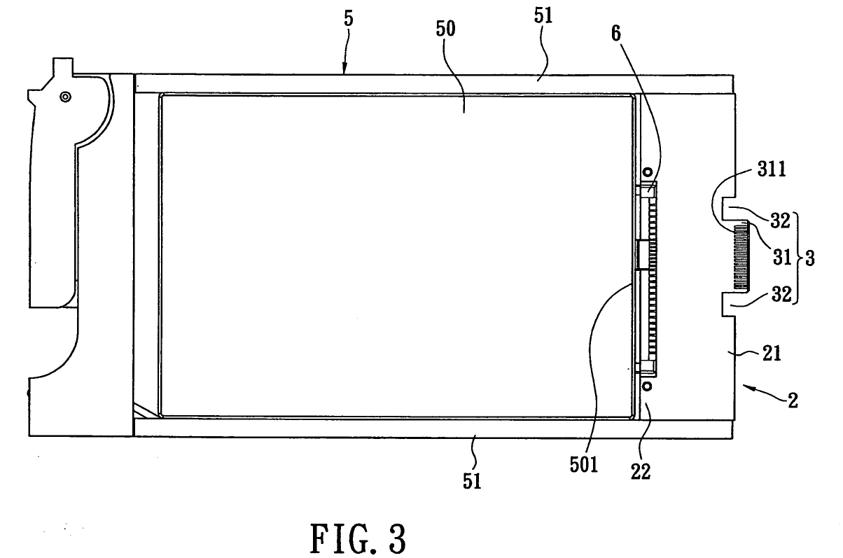

Please refer to FIG. 3, which shows the top view of the hard disk adaptor assembled to the hard disk. The substrate 2 of the hard disk adaptor 1 (refer to FIG. 1) is disposed on the hard disk box 5. The hard disk box 5 has an attached apparatus 51 for attaching a hard disk 50. The communicating side 22 of the substrate 2 of the hard disk adaptor 1 and a communicating terminal 501 of the hard disk 50 are electrically coupled with a communicating port 6. Therefore, the substrate 2 is attached stably with the hard disk 50, and transfers the interface of the hard disk 50 to another standard.

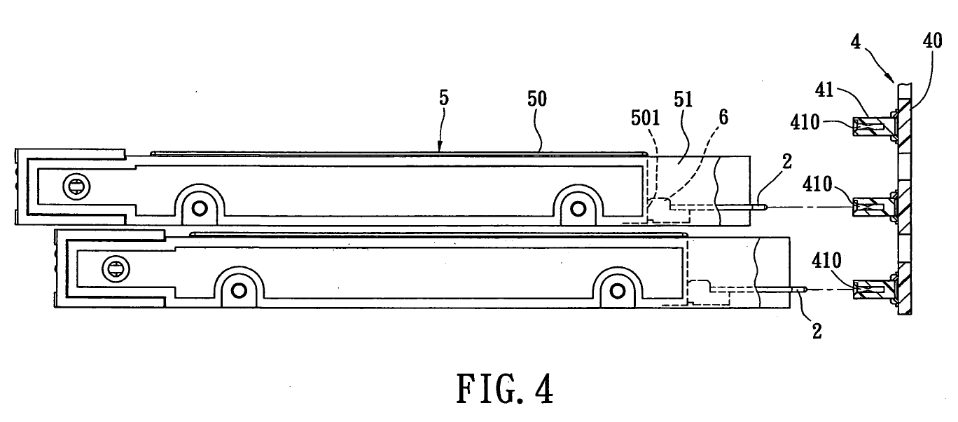

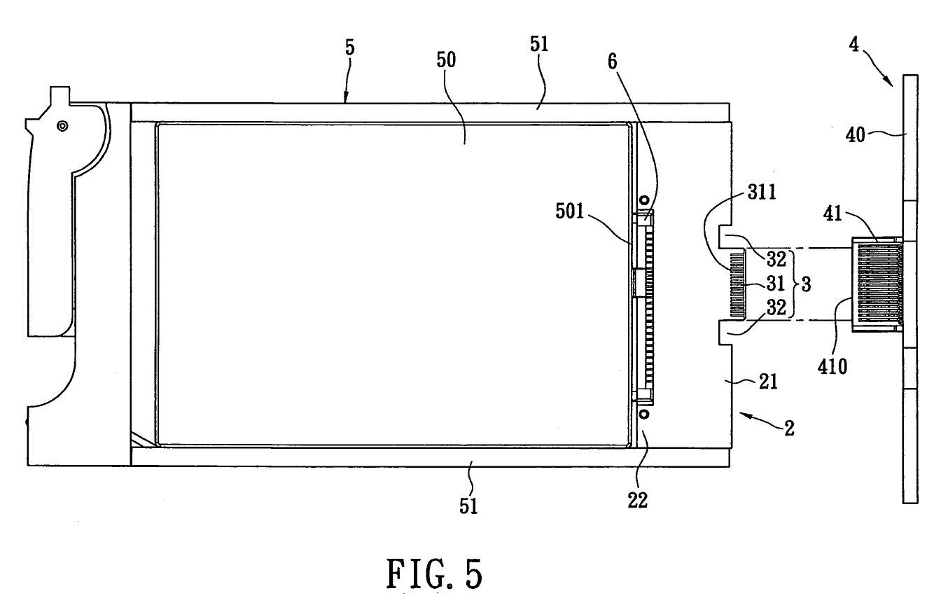

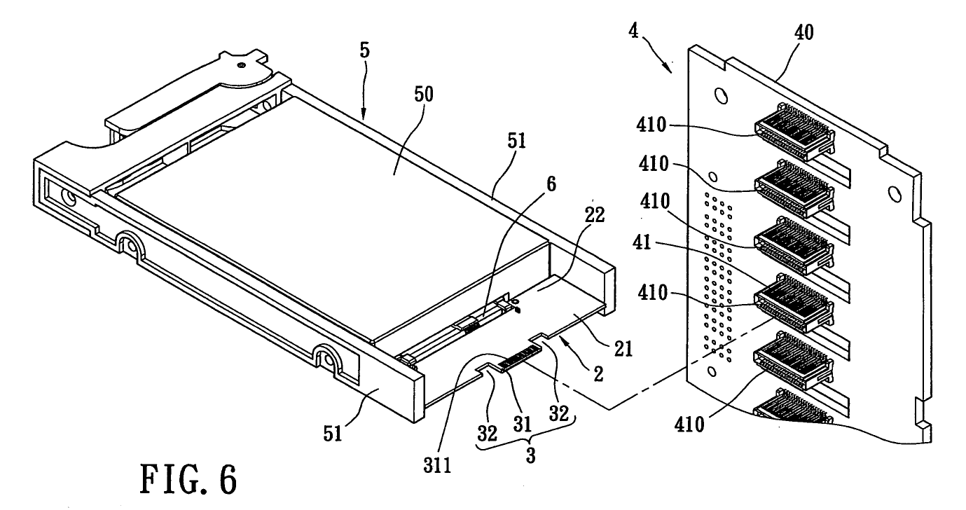

Please refer to FIGS. 4 to 6, the side view, top view, and perspective view of the hard disk adaptor assembled to the hard disk and the middle board. The substrate 2 of the hard disk adaptor 1 (refer to FIG. 1) is connected with the hard disk 50 stably. The substrate 2 is electrically coupled with the middle board 4 via the interface structure 3. Therefore, the hard disk 50 may have different interfaces, which are transferred to the same interface standard via the substrate 2 and interface structure 3. The middle board 4 has a plate 40 and a plurality of connecting ports 41 disposed on the plate 40. The connecting ports 41 correspond to the Mini-Serial Attached SCSI standard.

Each of the connecting ports 41 are spaced at intervals to each other. The connecting port 41 has a conductive structure 410 corresponding to the thickness D of the substrate 2 of the hard disk adaptor 1 (refer to FIG. 1). Because the thickness D of the substrate 2 of the hard disk adaptor 1 corresponds to the Mini-Serial Attached SCSI standard, the size of the conductive structure 410 of the connecting port 41 of the substrate 4 is reduced and the available surface of the middle board 4 is increased. Therefore, the circuit design of the middle board is simpler.

The protruding portion 31 and the concaving portions 32 of the interface structure 3 are placed with the traditional interface having a plug with a wire inserted into the socket. Due to the design of the protruding portion 31 and the concaving portions 32, the substrate 2 connects to the conductive structure 410 of the connecting port 41 via the conductive portion 311 of the protruding portion 31 that is connected to the conductive structure 410 of the connecting port 41. Therefore, the interface is transferred and signal transference rises.

The number of pins of the conductive portion 311 and the conductive structure 410 can be determined by the user's requirements. The connecting port 41 is inserted into the concaving portions 32 for the stability of the transference between the protruding portion 31 and the connecting port 41.

Each of the hard disk adaptors 1 connects to the connecting ports 41 of the middle board 4 and the hard disks 50, respectively. Therefore, the different interfaces of the hard disks 50 are transformed into the same interface. The type of interface structure 3 connecting to the middle board 4 is “plate to board”, and that is replaced with the plug with a wire inserted into the socket in prior art.

Due to the structure of the interface structure 3, the connecting side 21 of the substrate 2 is connected to the connecting port 41 of the middle board 4 and the communicating side 22 is connected to the hard disk 50. The advantages of the hard disk adaptor having the interface structure are described below:

1. Because the hard disk adaptor of the present invention connected to the middle board by the substrate and interface structure is “plate to board”, manufacturing costs are reduced.

2. Because the thickness of the substrate of the hard disk adaptor corresponds to the Mini-Serial Attached SCSI standard, the size of the conductive structure of the connecting port of the substrate is reduced and the surface of the middle board is increased. Therefore, the circuit design of the middle board is simpler.

3. Because the conductive portion of the protruding portion of the interface structure is a plug with a plate connecting mode, the cost of the prior plug is eliminated and the quality of high-speeding signal is improved.

4. A part of the connecting side of the substrate is used by the interface structure, leaving the other part of the connecting side available.

5. The concaving portions and the protruding portion of the interface structure are replaced with the transiting structure of the prior plug and socket. Therefore, the design of the hard disk adaptor and the circuit of the middle board are simpler, and design costs are reduced.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A hard disk adaptor, comprising:
a substrate having a connecting side and a communicating side opposite to the connecting side; and
an interface structure formed on the connecting side, the interface structure corresponding to the Mini-Serial Attached SCSI standard.

2. The hard disk adaptor as claimed in claim 1, wherein the thickness of the substrate corresponds to the Mini-Serial Attached SCSI standard.

3. The hard disk adaptor as claimed in claim 1, wherein the interface structure has a protruding portion and two concaving portions formed on the two opposite sides of the protruding portion, and the protruding portion and the concaving portions correspond to the Mini-Serial Attached SCSI standard.

4. The hard disk adaptor as claimed in claim 1, wherein the protruding portion has a conductive portion.

5. The hard disk adaptor as claimed in claim 1, wherein the upper and lower surfaces of the interface structure have a conductive portion.

6. The hard disk adaptor as claimed in claim 1, wherein the interface structure is disposed on the middle of the connecting side.

7. The hard disk adaptor as claimed in claim 1, wherein the substrate is connected to a middle board and a hard disk, the interface structure of the connecting side of the substrate is connected to the middle board, and the communicating side is connected to the hard disk.
